(19) United States
(12) Patent Application Publication
(10) Pub. No.: US 2025/0354842 A1
(43) Pub. Date: Nov. 20, 2025

(54) FIBER OPTIC-BASED HAZARDOUS ENVIRONMENTAL FLOWMETER

(71) Applicant: FANUC AMERICA CORPORATION, Rochester Hills, MI (US)

(72) Inventors: David Moore, Macomb, MI (US); Xianpai Zeng, Bruce TWP, MI (US)

(21) Appl. No.: 18/667,270

(22) Filed: May 17, 2024

(51) Int. Cl. G01F 1/06; B05B 12/00

(52) U.S. Cl. CPC G01F 1/065; B05B 12/006

(57) ABSTRACT

A flowmeter system including a flowmeter having a body defining a flow channel and a recess. A paddle wheel is positioned in the recess and is rotatable in response to gas flow through the channel. An optical source provides a light beam on an input cable that crosses the recess and is received by an output cable. A light detector receives the light beam from the output cable. The light beam is intermittently interrupted by the paddle wheel as the paddle wheel rotates so that the light beam on the output cable is a pulsed light beam. Processing electronics converts the pulsed light beam to a rotational speed of the paddle wheel that is then converted to a gas flow rate through the flow channel. The flowmeter is positioned in the hazardous environment of a painting robot and the processing electronics is positioned outside of the hazardous environment.

### BACKGROUND

### Field

This disclosure relates generally to a flowmeter for measuring the flow rate of a gas and, more particularly, to a flowmeter for measuring the flow of hazardous gases through a robot, where the flowmeter includes a paddle wheel that interrupts a light beam as the paddle wheel rotates to provide the measured flow rate of the air.

### Discussion of the Related Art

Robots are known to perform a variety of tasks including painting an object, such as a vehicle body. A typical robotic painting station for painting, for example, the exterior surfaces of vehicle bodies in both a continuous conveyance and stop station systems includes a spray booth, a plurality of painting robots and opener/closer robots disposed on a periphery thereof. These robots can be mounted on the floor, the wall, the ceiling or side rails. Painting robots carry either spray guns or rotary applicators for directing atomized paint toward the vehicle body. The spray booth typically includes sophisticated environmental and air handling equipment that treats and exhausts the vapor-laden air from the spray booth, and prevents the paint vapors from entering an operator aisle where people are present.

The atomized paint that is sprayed from the robot creates a combustible environment in the spray booth as a result of paint vapor, generally referred to herein as hazardous gases. It is necessary to prevent the hazardous gases from entering the robot during operation of the robot, which could be ignited when electrical power is provided to the robot motors. One known protection strategy for removing and preventing hazardous gases from entering the robot is referred to as a purge and pressurization strategy. Purging is performed to evacuate any hazardous gases that may have collected inside the robot and other non-intrinsically safe (IS) devices during periods of robot downtime where either the monitoring of the pressure or air supply to the chamber was discontinued for any period of time. For this strategy, clean air is forced into the robot to remove hazardous gases that may have accumulated therein before the robot is started. Pressurization is performed to maintain positive pressure in the robot during operation of the robot to prevent hazardous gases from entering the robot. It is necessary to measure the flow rate of the air during both the purge and pressurization operations to ensure that the proper volume of air is provided to the robot during the purge operation and to ensure that the proper positive pressure is maintained during the pressurization operation.

Existing purge systems often rely on one set of differential pressure sensors to measure flow rate during the purging operation of hazardous gases from the robot, or other powered enclosure, operating inside the hazardous environment. Another set of differential pressure sensors is required to monitor the relative pressure between the purged and pressurized cavity and the outside combustible environment, where the differential pressure sensors are continuously monitored to confirm the internal pressurized cavity is always at a higher relative pressure than the outside combustible environment to assure any leakage is clean air from inside the pressurized cavity to the hazardous environment and not the other direction. However, these types of pressure sensors are electronic devices that require electrical power to be provided to the hazardous environment, which requires approval from relevant agencies, and which adds to the product cost. Further, the electrical contacts employed in these pressure sensors frequently open and close at high frequency in response to turbulent flows, which leads to a reduced lifespan of the sensors due to wear. Also, the electrical contacts employed in these pressure sensors are prone to carbon build-up, which causes poor electrical connections.

### SUMMARY

The following discussion discloses and describes a flowmeter system that is part of a purge and pressurization system associated with a painting robot that purges hazardous gases from the robot before robot operation and maintains positive pressure within the robot during operation of the robot. The flowmeter system includes a flowmeter positioned in the robot and having a body with a flow input end and a flow output end and defining a channel therebetween and a recess in fluid communication with the channel. A paddle wheel is positioned in the recess and extends into the channel and is rotatable on a shaft in response to gas flow through the channel. A check valve is positioned in the channel proximate the output end of the body, and allows gas flow through the channel from the input end to the output end and prevents gas flow through the channel from the output end to the input end. A gas flow conditioner is mounted to the input end of the body, and includes a plurality of holes through which the gas flows and into the channel so as to reduce turbulence in the gas flow. An optical input cable is coupled to the body proximate the recess and an optical output cable coupled to the body also proximate the recess. Processing electronics positioned outside of the robot in a non-hazardous environment includes an optical source that provides a light beam on the optical input cable that crosses the recess and is received by the optical output cable. The processing electronics also includes a light detector that receives the light beam from the optical output cable. The light beam is intermittently interrupted by the paddle wheel as the paddle wheel rotates so that the light beam on the optical output cable is a pulsed light beam. The processing electronics converts the pulsed light beam to a rotational speed of the paddle wheel that is converted to a gas flow rate through the channel.

Additional features of the disclosure will become apparent from the following description and appended claims, taken in conjunction with the accompanying drawings.

### BRIEF DESCRIPTION OF THE DRAWINGS

FIG. 1 is an illustration of a robot system including a painting robot and a purge and pressurization assembly;

FIG. 2 is an isometric view of an optical flowmeter positioned in the robot;

FIG. 3 is a cut-away isometric view of the optical flowmeter;

FIG. 4 is an isometric view of a paddle wheel employed in the optical flowmeter;

FIG. 5 is a side view of a paddle wheel; and

FIG. 6 is schematic type diagram of a flowmeter system including the optical flowmeter and signal processing electronics.

### DETAILED DESCRIPTION OF THE EMBODIMENTS

The following discussion of the embodiments of the disclosure directed to a flowmeter for measuring the flow of air through a robot, where the flowmeter includes a paddle wheel that interrupts a light beam as the paddle wheel rotates to provide the measured flow rate of the air, is merely exemplary in nature, and is in no way intended to limit the disclosure or its applications or uses.

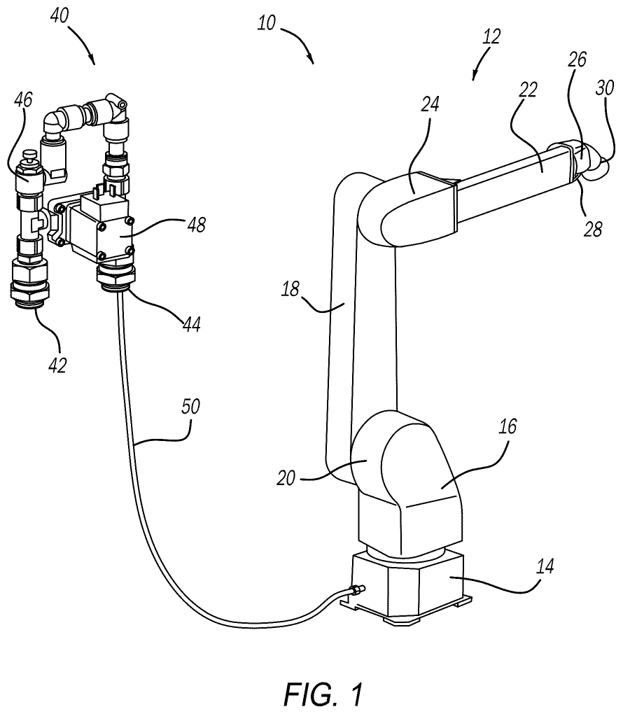

FIG. 1 is an illustration of a robot system 10 including a painting robot 12 mounted to a fixed base 14, where the robot 12 is intended to represent any painting robot suitable for the purposes discussed herein. A turret 16 is rotatably mounted to the fixed base 14. An inner arm 18 is rotatably coupled to the base 16 by a joint 20, an outer arm 22 is rotatably coupled to the inner arm 18 by a joint 24, and a wrist member 26 is rotatably coupled to the outer arm 22 by a joint 28. A paint applicator 30 is fixedly attached to the wrist member 26 at an angle optimized for a painting application.

The robot system 10 also includes a purge and pressurization assembly 40 that removes hazardous gasses within the robot 12 when the robot 12 is being prepared to operate and prevents hazardous gases from entering the robot 12 when the robot 12 is operating. The assembly 40 includes an air inlet port 42, an air outlet port 44, a needle valve 46 and an air solenoid valve 48. An air supply hose 50 is coupled to the outlet port 44 and a purge switch (not shown) within the mounting stand 14. Before the robot 12 is turned on, a large volume of air is supplied to the robot 12 through the solenoid valve 48, the hose 50 and the purge switch and is circulated throughout channels (not shown) in the robot 12. The purge switch measures the flow rate of the air being supplied to the robot 12 and a timer is used to ensure the proper volume of air is provided for the purge. The air flows through the channels in the robot 12 and out of the robot 12 through an exhaust port. While the robot 12 is operational, a small volume of air is provided to the robot 12 through the needle valve 46, which bypasses the solenoid valve 48, through the hose 50 and the purge switch and the channels to maintain positive pressure in the robot 12, where the purge switch again measures the flow rate of the air to ensure the proper amount of pressure.

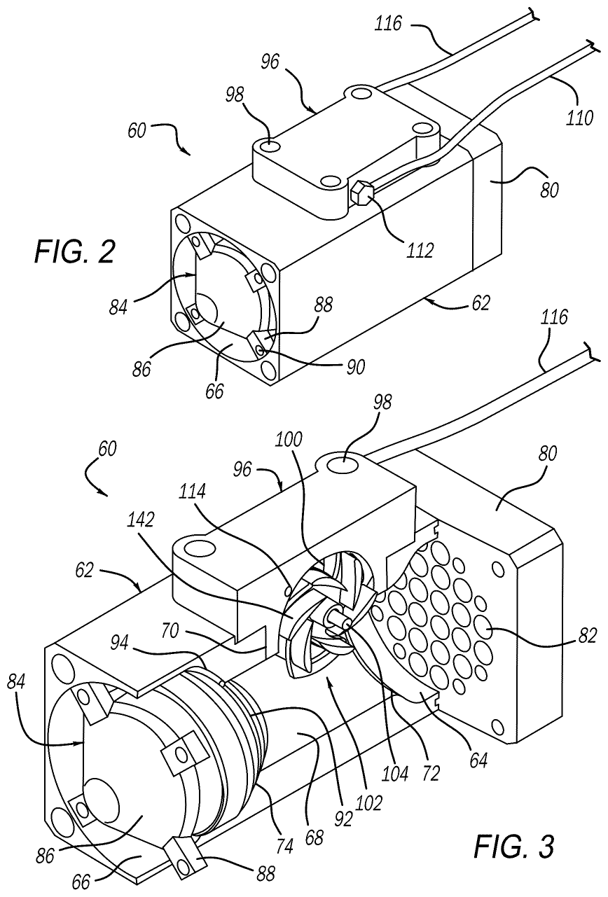

FIG. 2 is an isometric view and FIG. 3 is a cut-away isometric view of an optical flowmeter 60 that is mounted within the fixed base 14 and receives the air from the hose 50 in combination with the purge switch. The flowmeter 60 includes a housing or body 62, made of, for example, aluminum, that defines a cylindrical input channel region 64 at an airflow input end of the flowmeter 60, a cylindrical output channel region 66 at an airflow output end of the flowmeter 60, a cylindrical center flow channel 68 and a top recess 70, where the cylindrical regions 64 and 66 have a larger diameter than the center channel 68. A tapered channel portion 72 is provided between the input region 64 and the center channel 68 so that as the air flows into the channel 68 it speeds up so that low air flow rates can be measured, where the diameter of the channel 68 is important to the design of the flowmeter 60. A tapered channel portion 74 is provided between the output region 66 and the center channel 68 so that as the air flows from the channel 68 to the output region 66 it slows down.

A gas flow conditioner 80, made of, for example, a nylon composite, is mounted and secured to the input end of the body 62 and includes a series of holes 82 that are configured to remove turbulence in the airflow to obtain a stable flow rate measurement. The number and diameter of the holes 82 in the conditioner 80 are determined by the path of the airflow through the channels in the robot 12 and the amount of turbulence that is created therefrom.

A check valve 84, made of, for example, a nylon composite, is secured within the body 62 at the output end of the body 62 and includes a fixed part 86 secured to the body 62 by tabs 88 and bolts 90, and a movable part 92 that seals against a seat 94 in the tapered portion 74 under spring bias by a spring (not shown). When there is no airflow through the channel 68 or the pressure in the channel 68 is so low that the force exerted by the pressure on the tapered portion 74 is less than the spring bias force, the movable part 92 is pushed against the seat 94 and air is prevented from entering the robot 12 through the output end of the flowmeter 60. When there is airflow through the channel 68 and the pressure within the channel 68 is high enough to exert a force on the tapered portion 74 that could overcome the spring bias force, the movable part 92 is pushed away from the seat 94 and air is allowed to flow through the channel 68 from the input end to the output end.

A cartridge 96, made of, for example, a nylon composite, is inserted into the recess 70 and is secured to the body 62 by bolts 98. The cartridge 96 includes a cavity 100 that accepts a paddle wheel 102, made of, for example, a nylon composite, that is freely rotatable therein on a shaft 104. The inertia of rotation of the paddle wheel 102 also helps to smooth out the flow variations caused by turbulence, which provides a more consistent flow measurement. Airflow through the channel 68 from the input end to the output end of the body 62 causes the paddle wheel 102 to rotate in the clockwise direction.

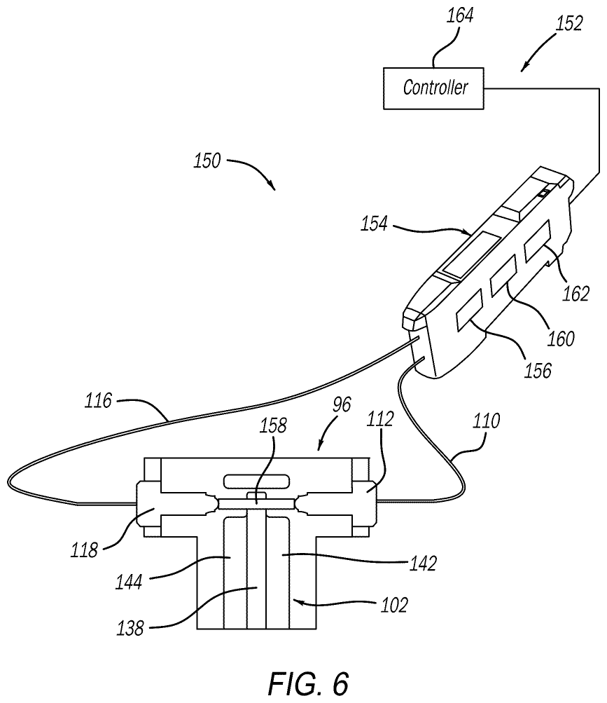

As will be discussed in detail below, a light beam is sent to the cartridge 96 on an input fiber cable 110 coupled to the cartridge 94 by a fitting 112. The beam enters the cartridge 96 through a hole 114 and crosses the cavity 100 to be received by an output fiber cable 116 through a fitting 118 (see FIG. 6). The paddle wheel 102 is positioned within the cavity 100 so that as the paddle wheel 102 rotates the beam will be intermittently blocked by the paddle wheel 102 and the output fiber cable 116 will receive pulses of light having a frequency and pulse width determined by the speed of rotation of the paddle wheel 102, which is determined by the flow rate of the air through the channel 68. The pulses of light are converted to electric signals by an amplifier device outside of the hazardous environment of the painting booth, thus eliminating the need for agency approval of the flowmeter 60.

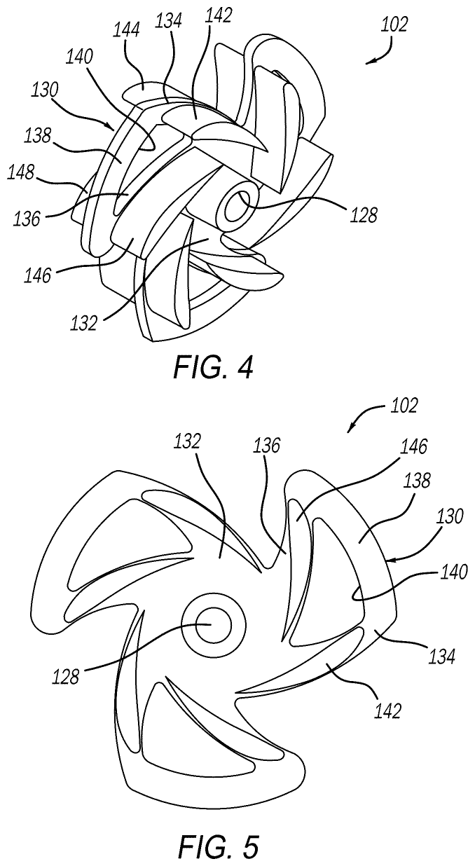

The paddle wheel 102 is configured to operate effectively at very low flow rates. FIG. 4 is an isometric view and FIG. 5 is a side view of the paddle wheel 102 separated from the flowmeter 60. The paddle wheel 102 includes three spaced apart radial paddle elements 130 extending from a flat web member 132 having a hole 128 through which the shaft 104 extends. Each paddle element 130 includes a first curved segment 134, a second curved segment 136 and a detecting segment 138 coupled to the first and second segments 134 and 136 and all defining an opening 140. A set of opposing airfoil members 142 and 144 are provided on opposite sides of each of the first curved segments 134 and a set of opposing airfoil members 146 and 148 are provided on opposite sides of each of the second curved segments 136. The airfoil members 142-148 are shaped, angled and configured relative to the channel 68 so that as air flows over the airfoil members 142-148, the lift and drag created by the airfoil members 142-148 will cause the paddle wheel 102 to more efficiently rotate so that the paddle wheel 102 properly rotates at low flow rates.

FIG. 6 is schematic type diagram of a flowmeter system 150 including a cut-away of the cartridge 96 in the optical flowmeter 60 and signal processing electronics 152, where the electronics 152 are outside of the hazardous environment of the painting booth. The electronics 152 include an optical transceiver and amplifier device 154 having an optical source 156, such as a diode, configured to send an optical beam 158 down the input fiber cable 110 to the fitting 112 so that the beam 158 crosses the cavity 100 and is intermittently interrupted by the detecting segments 138 as the paddle wheel 102 rotates. The interrupted beam is sent into the fitting 118 and down the output fiber cable 116 as optical pulses that are received by a sensor 160, such as a photodiode, in the device 154, where the optical pulses are converted to electrical pulses. The electrical pulses are amplified by an amplifier 162 in the device 154 and the amplified pulse train is sent to a controller 164. The controller 164 employs an algorithm that converts the electrical pulses to a turning speed, i.e., revolutions per minute (RPM), of the paddle wheel 102, which is linearly proportional to the flow rate of air through the channel 68.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. A flowmeter system comprising:
a flowmeter including a body having a flow input end and a flow output end and defining a flow channel therebetween and a recess in fluid communication with the channel, a paddle wheel positioned in the recess and extending into the channel and being rotatable on a shaft in response to gas flow through the flow channel, and a check valve positioned in the flow channel proximate the output end of the body, said check valve allowing gas flow through the flow channel from the input end to the output end and preventing gas flow through the flow channel from the output end to the input end;
an optical input cable coupled to the body proximate the recess;
an optical output cable coupled to the body proximate the recess; and
processing electronics including an optical source providing a light beam on the optical input cable that crosses the recess and is received by the optical output cable, said processing electronics further including a light detector that receives the light beam from the optical output cable, wherein the light beam is intermittently interrupted by the paddle wheel as the paddle wheel rotates so that the light beam on the optical output cable is a pulsed light beam, and wherein the processing electronics converts the pulsed light beam to a rotational speed of the paddle wheel that is converted to a gas flow rate through the flow channel.

2. The flowmeter system according to claim 1 wherein the paddle wheel includes a web portion and a plurality of spaced apart radial members extending from the web member where each radial member includes a detecting portion that blocks the light beam as the paddle wheel rotates.

3. The flowmeter system according to claim 2 wherein each radial member includes a first curved segment coupled to one end of the detecting portion and a second curved segment coupled to an opposite end of the detecting portion so that the first curved segment, the second curved segment and the detecting portion define a central opening.

4. The flowmeter system according to claim 3 wherein each radial member further includes opposing airfoil members on opposite sides of the first curved segment and opposing airfoil members on opposite sides of the second curved segment, and wherein the airfoil members are configured so that lift and drag on the airfoil members as the gas flows over the airfoil members causes increased rotation of the paddle wheel.

5. The flowmeter system according to claim 1 wherein the flowmeter further includes a gas flow conditioner mounted to the input end of the body, said gas flow conditioner including a plurality of holes through which the gas flows and into the flow channel so as to reduce turbulence in the gas flow.

6. The flowmeter system according to claim 1 wherein the flow channel includes a cylindrical input portion at the input end of the body, a cylindrical output portion at the output end of the body, a cylindrical center portion between the cylindrical input portion and the cylindrical output portion, a first tapered portion between the cylindrical input portion and the cylindrical center portion and a second tapered portion between the cylindrical output portion and the cylindrical center portion, and wherein the cylindrical input portion and the cylindrical output portion have a larger diameter than the cylindrical center portion.

7. The flowmeter system according to claim 1 wherein the flowmeter further includes a cartridge inserted into the recess and secured to the body, said cartridge including a cavity and said paddle wheel being rotatably mounted within the cavity on the shaft.

8. The flowmeter system according to claim 1 wherein the flowmeter system is part of a purge and pressurization system associated with a robot that purges hazardous gases from the robot before robot operation and maintains positive pressure within the robot during operation of the robot, said flowmeter being located in the robot and said processing electronics being located outside of the robot in a non-hazardous environment.

9. The flowmeter system according to claim 8 wherein the robot is a painting robot.

10. A flowmeter system that is part of a purge and pressurization system associated with a painting robot that purges hazardous gases from the robot before robot operation and maintains positive pressure within the robot during operation of the robot, said flowmeter system comprising:
a flowmeter including a body having a flow input end and a flow output end and defining a flow channel therebetween and a recess in fluid communication with the channel, a paddle wheel positioned in the recess and extending into the channel and being rotatable on a shaft in response to gas flow through the flow channel, a check valve positioned in the flow channel proximate the output end of the body, said check valve allowing gas flow through the flow channel from the input end to the output end and preventing gas flow through the flow channel from the output end to the input end, and a gas flow conditioner mounted to the input end of the body, said gas flow conditioner including a plurality of holes through which the gas flows and into the flow channel so as to reduce turbulence in the gas flow, said flowmeter being located in the robot;
an optical input cable coupled to the body proximate the recess;
an optical output cable coupled to the body proximate the recess; and
processing electronics including an optical source providing a light beam on the optical input cable that crosses the recess and is received by the optical output cable, said processing electronics further including a light detector that receives the light beam from the optical output cable, wherein the light beam is intermittently interrupted by the paddle wheel as the paddle wheel rotates so that the light beam on the optical output cable is a pulsed light beam, and wherein the processing electronics converts the pulsed light beam to a rotational speed of the paddle wheel that is converted to a gas flow rate through the flow channel, said processing electronics being located outside of the robot in a non-hazardous environment.

11. The flowmeter system according to claim 10 wherein the paddle wheel includes a web portion and a plurality of spaced apart radial members extending from the web member where each radial member includes a detecting portion that blocks the light beam as the paddle wheel rotates.

12. The flowmeter system according to claim 11 wherein each radial member includes a first curved segment coupled to one end of the detecting portion and a second curved segment coupled to an opposite end of the detecting portion so that the first curved segment, the second curved segment and the detecting portion define a central opening.

13. The flowmeter system according to claim 12 wherein each radial member further includes opposing airfoil members on opposite sides of the first curved segment and opposing airfoil members on opposite sides of the second curved segment, and wherein the airfoil members are configured so that lift and drag on the airfoil members as the gas flows over the airfoil members causes increased rotation of the paddle wheel.

14. The flowmeter system according to claim 10 wherein the flow channel includes a cylindrical input portion at the input end of the body, a cylindrical output portion at the output end of the body, a cylindrical center portion between the cylindrical input portion and the cylindrical output portion, a first tapered portion between the cylindrical input portion and the cylindrical center portion and a second tapered portion between the cylindrical output portion and the cylindrical center portion, and wherein the cylindrical input portion and the cylindrical output portion have a larger diameter than the cylindrical center portion.

15. The flowmeter system according to claim 10 wherein the flowmeter further includes a cartridge inserted into the recess and secured to the body, said cartridge including a cavity and said paddle wheel being rotatably mounted within the cavity on the shaft.

16. A flowmeter comprising:
a body having a flow input end and a flow output end and defining a flow channel therebetween and a recess in fluid communication with the flow channel; and
a paddle wheel positioned in the recess and extending into the channel and being rotatable on a shaft in response to gas flow through the flow channel, said paddle wheel including a web portion and a plurality of spaced apart radial members extending from the web member where each radial member includes a detecting portion that blocks a light beam as the paddle wheel rotates, wherein each radial member includes a first curved segment coupled to one end of the detecting portion and a second curved segment coupled to an opposite end of the detecting portion so that the first curved segment, the second curved segment and the detecting portion define a central opening.

17. The flowmeter according to claim 16 wherein each radial member further includes opposing airfoil members on opposite sides of the first curved segment and opposing airfoil members on opposite sides of the second curved segment, and wherein the airfoil members are configured so that lift and drag on the airfoil members as the gas flows over the airfoil members causes increased rotation of the paddle wheel.

18. The flowmeter according to claim 16 wherein the flow channel includes a cylindrical input portion at the input end of the body, a cylindrical output portion at the output end of the body, a cylindrical center portion between the cylindrical input portion and the cylindrical output portion, a first tapered portion between the cylindrical input portion and the cylindrical center portion and a second tapered portion between the cylindrical output portion and the cylindrical center portion, and wherein the cylindrical input portion and the cylindrical output portion have a larger diameter than the cylindrical center portion.

19. The flowmeter according to claim 16 further comprising a cartridge inserted into the recess and secured to the body, said cartridge including a cavity and said paddle wheel being rotatably mounted within the cavity on the shaft.

20. The flowmeter according to claim 16 wherein the flowmeter is part of a purge and pressurization system associated with a painting robot that purges hazardous gases from the robot before robot operation and maintains positive pressure within the robot during operation of the robot, said flowmeter being located in the robot and said processing electronics being located outside of the robot in a non-hazardous environment.
